(19) United States
(12) Patent Application Publication
(10) Pub. No.: US 2016/0007263 A1
(43) Pub. Date: Jan. 7, 2016

(54) A System, Method, Computer Program and Data Signal for the Re-Routing of Enterprise Voice Traffic

(71) Applicant: NORWOOD SYSTEMS PTY LTD, Nedlands, Western Australia (AU)

(72) Inventors: Paul Frederick Norwood Ostergaard, Nedlands, Western Australia (AU); David Alexander WILSON, Nedlands, Western Australia (AU); Andrew Phillip MASON, Nedlands, Western Australia (AU)

(73) Assignee: Norwood Systems Pty Ltd

(21) Appl. No.: 14/768,782

(22) PCT Filed: Feb. 20, 2014
(86) PCT No.: PCT/AU2014/000152

§ 371 Date: Aug. 19, 2015

(30) Foreign Application Priority Data
Feb. 20, 2013 (AU) 2013200960

(51) Int. Cl. H04W 40/12; H04W 4/16; H04W 64/00; H04W 40/20

(52) U.S. Cl. CPC H04W 40/12; H04W 40/20; H04W 4/16; H04W 64/006

(57) ABSTRACT

A method for re-routing data from a first communications device (200e) to a second communications device (202e) via one of a plurality of networks (206, 208), comprising the steps of a computing system (200a) including a network access point communicating with the first communications device (200e) to receive data and/or information associated with the first communications device (200e) and/or with the second communications device (202e), and to determine the location of the first communications device (200e) and the location of the second communications device (202e) on the basis of the received data and/or information, wherein upon determining the location of both the first communications device (200e) and the second communications device (202e), the computing system (200a) selects one of the plurality of networks (206, 208) to connect the first communications device (200e) and the second communications device (202e).

### TECHNICAL FIELD

The present invention relates to a system, method, computer program and data signal for the re-routing of data. Embodiments of the invention find specific, but not exclusive, use in the re-routing of voice data via an Internet Protocol (IP) network, such as a wireless (‘Wi-Fi’) network, using a conventional telecommunications network, such as a Public, Switched Telephone Network (PSTN).

### BACKGROUND ART

The following discussion of the background art is intended to facilitate an understanding of the present invention only. The discussion is not an acknowledgement or admission that any of the material referred to is or was part of the common general knowledge as at the priority date of the application.

Mobile or cell lone technology is now mature and well developed. In fact, as of 2010 there were 6 billion mobile phone subscribers around the world, which represents almost one mobile phone for every man, woman and child on Earth. There are few technologies in the history of the world that have become so pervasive and so embedded in daily life and culture.

However, despite the explosion in and frenzied uptake of telecommunications and associated computing technology, there are still financial barriers to using mobile phones across different countries and jurisdictions, Generally each country or jurisdiction operates an independent telecommunications network.

Since the deployment of the 2nd generation (2G) mobile network standards, including the “Global System for Mobile Communications (GSM)” during the early 1990's, mobile phone users have been able to utilise a ‘global roaming’ feature when connected to cellular networks other than their home (default) network, namely the ability for a user to automatically make and receive voice calls, send and receive data, or access other services when travelling outside the geographical coverage area of the home network (of their respective country/jurisdiction), by means of using a visited network.

However, many users have experienced high costs (tariffs) associated with using the facilities of a visited network. The tariffs can be up to 100 times the cost of an equivalent fixed network PSTN international call. Therefore, cellular roaming is seen as an expensive communications service, especially when compared to PSTN (or fixed line) telephony.

Moreover, when a user is travelling or outside of their office, the user is de-coupled from his/her desk phone telephone identification (ID), i.e. phone number, and is forced to dial back into their organisation to check for missed calls and voice-mail messages for their desk phone number. The only workaround to date for this has been to forward calls to one's desk phone to a mobile phone, which also can be expensive when travelling, due to the same issue with global roaming tariffs. To date, Private Branch eXchange (PBX) dial plans have been static and have not adapted to the movements from city-to-city or country-to-country of an increasingly mobile workforce.

It is against this background that embodiments of the present invention have been developed.

### SUMMARY OF INVENTION

It is an object of the present invention to overcome, or at least ameliorate one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, a preferred embodiment of the present invention is disclosed.

In a first aspect, the present invention provides a method for re-routing voice data from a first communications device to a second communications device via one of a plurality of networks, wherein at least one of the plurality of networks includes a Public Switched Telephone Network (PSTN), the method comprising the steps of a computing system including a network access point arranged to communicate with the first communications device to receive data and/or information associated with the first communications device and/or with the second communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device, the network including the PSTN being selected according to criteria including quality of communication between the first communications device and the second communications device.

The first communication device and/or the second communications device may comprise a wireless communication enabled device. Preferably, the wireless communication enabled device is a smartphone such as provided under the trademarks Apple™ iPhone™, Android™ or Blackberry.

The data and/or information associated with the first communications device may comprise an indication that the first communications device is within a communication area associated with the network access point within which it is operable to establish a connection. The method may comprise automatically receiving the indication from the first communication device when it enters the communication area, and determining that the location of the first communications device corresponds to the location of the communication area.

The step of determining the location of the first communications device may comprise one or more of: establishing a connection for the communication between the first communications device and the computing system via the network access point, and determining the location of the first communications device on the basis of the connection being established; querying a position sensor and/or navigation system of the first communications device, which may comprise a Global Positioning System (GPS), to determine the location of the first communications device: and using a service that determines location based on what network access point(s), which may include Wi-Fi access points or cell sites associated with cellphone towers, are visible (available) to the first communications device, and as described at, for example http://www.skyhookwireless.com/howitworks/ or https://developers.google.com/maps/documentation/business/geolocation/), to determine the location of the first communications device.

The data and/or information associated with the first communications device may include one or more of; an original identification for the first communications device; an identification of an originating location of the first communications device; and an identification of a present location of the first communications device. The method may comprise the further step of assigning a temporary identification to the first communications device, which may be in the form of a temporary identification number, such a Public Switched Telephone Network (PSTN) indial number.

The data and/or information associated with the second communications device may include one or more of: an original identification for the second communications device; a temporary identification for the second communications device; an identification of an originating location of the second communications device; and an identification of a present location of the second communications device.

The method may comprise the further step of propagating at least some of the data and/or information associated with the first communications device and/or the second communications device to at least one other computing system on at least of the plurality of networks.

The at least one other computing system may comprise a telephone exchange and/or an Internet exchange, and preferably a Private Branch eXchange (PBX). The method may comprise reconfiguring the telephone exchange and/or the Internet exchange to connect the first communications device and the second communications devices. The reconfiguring may occur automatically on the occurrence of a prescribed event. The prescribed event may comprise determination of the location of the first communications device.

It is preferred that dynamic reconfiguration of a PBX local to the determined location of the first communications device and other PBXs in the plurality of networks occurs to seamlessly reroute calls from the first communications device to the second communications device.

The method may comprise the further step of utilising at least one parameter to select the one of the plurality of networks.

The method may comprise the further step of utilising the at least one parameter and an algorithm to select the one of the plurality of networks.

The at least one parameter may be the monetary cost of utilising the each one of the plurality of networks to connect the first communications device to the second communications device.

The method may comprise the further step of testing the at least one of the plurality of networks utilised by the resultant connection between the first communications device and the second communications device to determine the connectivity of the first communications device to the second communications device.

At least one of the first communications device and the second communications device may be a mobile (cell) telephone or a fixed (land) line telephone.

The second communications device may comprise the intended endpoint fore communication from the first communications device.

The voice data that is re-routed may comprise enterprise voice traffic.

In a second aspect, the present invention provides a system for re-routing voice data from a first communications device to a second communications device via one of a plurality of networks, wherein at least one of the plurality of networks includes a Public Switched Telephone Network (PSTN), the system comprising a computing system including a network access point arranged to communicate with the first communications device to receive data and/or information associated with the first communications device and/or with the second communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device, the network including the PSTN being selected according to criteria including quality of communication between the first communications device and the second communications device.

In a third aspect, the present invention provides a method for allocating an identification to a communications device in a system for re-routing voice data from the communications device via one of a plurality of networks, wherein at least one of the plurality of networks includes a Public Switched Telephone Network (PSTN), the network including the PSTN being selected according to criteria including quality of communication between the communications device and an other communications device, the method comprising the steps of a computing system including a network access point arranged to communicate with the communications device to receive data and/or information associated with the communications device, to determine the location of the communications device on the basis of the received data, analyze a plurality of identifications on the basis of decision criteria including the determined location to determine an identification available for allocation to the communications device, and dynamically allocate the determined available identification to the communications device on the basis of the decision criteria.

The decision criteria may include criteria additional to the determined location, including communication tariff cost, network coverage, and security policies.

The communications device may be a mobile (cell) telephone or a fixed (land) line telephone.

The identification may comprise a temporary identification assigned to the communications device, which may be in the form of a temporary identification number, such a Public Switched Telephone Network (PSTN) indial number. The temporary identification may belong to a block comprising a plurality of sequential temporary identifications available for assignment, the block identified by scanning the plurality of identifications for identifications available for allocation. The method may further comprise identifying a plurality of blocks, and reserving a block of the plurality of blocks having the largest number of sequential temporary identifications available for assignment.

The computing system may comprise an exchange. The exchange may comprise a telephone exchange and/or an Internet exchange, and preferably a Private Branch exchange (PBX). In such a case, the plurality of identifications may comprise a range of indial numbers.

In a fourth aspect, the present invention provides a system for allocating an identification to a communications device in a system for re-routing voice data from the communications device via one of a plurality of networks, wherein at least one of the plurality of networks includes a Public Switched Telephone Network (PSTN), the network including the PSTN being selected according to criteria including quality of communication between the communications device and an other communications device, the system for allocating the identification comprising a computing system including a network access point arranged, to communicate with the communications device to receive data and/or information associated with the communications device, to determine the location of the communications device on the basis of the received data, analyze a plurality of identifications on the basis of decision criteria including the determined location to determine an identification available for allocation to the communications device, and dynamically allocate the determined available identification to the communications device on the basis of the decision criteria.

In a fifth aspect, the present invention provides a method for reconfiguring a plurality of identifications, each identification of the plurality of identifications allocated or available for allocation to a corresponding communications device in a system for re-routing voice data from a first communications device to a second communications device via one of a plurality of networks, wherein at least one of the plurality of networks includes a Public Switched Telephone Network (PSTN), the network including the PSTN being selected according to criteria including quality of communication between the first communications device and the second communications device, the method comprising the steps of a computing system including a network access point arranged to communicate with the first communications device to receive data and/or information associated with the first communications device, to determine the location of the first communications device on the basis of the received data, analyze the plurality of identifications on the basis of decision criteria including the determined location to determine an identification available for allocation to the first communications device, dynamically allocate the determined available identification to the first communications device, and reconfigure the plurality of identifications on the basis of the allocation.

The decision criteria may include criteria additional to the determined location, including communication tariff cost, network coverage, and security policies.

The first communications device may be a mobile (cell) telephone or a fixed (land) line telephone.

The identification may comprise a temporary identification assigned to the first communications device, which may be in the form of a temporary identification number, such a Public Switched Telephone Network (PSTN) indial number. The temporary identification may belong to a block comprising a plurality of sequential temporary identifications available for assignment, the block identified by scanning the plurality of identifications for identifications available for allocation. The method may further comprise identifying a plurality of blocks, and reserving a block of the plurality of blocks having the largest number of sequential temporary identifications available for assignment.

The computing system may comprise an exchange. The exchange may comprise a telephone exchange and/or an Internet exchange, and preferably a plurality of Private Branch eXchanges (PBXs). In such a case, each of the plurality of identifications may comprise a dial plan on a respective of the plurality of PBXs.

The reconfiguring may comprise changing or optimising the plurality of identifications in a manner that, notwithstanding other benefits, may reduce call tariff costs, improve contactability and/or enhance security for users of the communications devices associated with the identifications.

In cases where the plurality of identifications comprises a fixed user number allocated to a first communications device comprising a fixed (land) line telephone associated with a user and a mobile user number allocated to a second communications device comprising a mobile (cell) telephone associated with the user, the reconfiguring may comprise redirecting calls made to the fixed user number, and preferably to the mobile user number, via a temporary identification assigned to the first communications device. Preferably the redirecting is performed by a PBX remote from the fixed (land) line telephone. More preferably, the redirecting is performed using diversion and translation pattern features of at least one PBX of a plurality of PBXs.

In a sixth aspect, the present invention provides a system for reconfiguring a plurality of identifications, each identification of the plurality of identifications allocated or available for allocation to a corresponding communications device in a system for re-routing voice data from a first communications device to a second communications device via one of a plurality of networks, wherein at least one of the plurality of networks includes a Public Switched Telephone Network (PSTN), the network including the PSTN being selected according to criteria including quality of communication between the first communications device and the second communications device, the system for reconfiguring the plurality of identifications comprising a computing system including a network access point arranged to communicate with the first communications device to receive data and/or information associated with the first communications device, to determine the location of the first communications device on the basis of the received data, analyze the plurality of identifications on the basis of decision criteria including the determined location to determine an identification available for allocation to the first communications device, dynamically allocate the determined available identification to the first communications device, and reconfigure the plurality of identifications on the basis of the

In a seventh aspect, the present invention provides a computer program including at least one command, which, when executed on a computing system, is arranged to perform the method steps in accordance with the first, third or fifth aspect of the invention.

In an eighth aspect, the present invention provides a computer readable medium incorporating a computer program in accordance with the seventh aspect of the invention.

In a ninth aspect, the present invention provides a data signal encoding at least one command and being arranged to be receivable by at least one computing device, wherein, when the encoded command is executed on the computing system, the computing system performs the method steps in accordance with the first, third, or fifth aspects of the invention.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the Invention as set out above. The description will be made with reference to the accompanying drawings in which:

FIG. 1 is an example computing system which is capable operating a device, system, method and/or computer program in accordance with an embodiment of the present invention;

FIG. 2 is an example system in accordance an embodiment of the present invention; and

FIG. 3 is a flow chart depicting the method steps carried out by a system in accordance with an embodiment of the present invention.

### DESCRIPTION OF EMBODIMENTS

### General Overview

The present invention relates generally to a system, method, computer program and data signal for the re-routing of voice data from one point (communications device) to another point (communications device).

In more detail, one aspect of the embodiments described herein provides a method for re-routing communications signals, and preferably voice traffic passing through an enterprise Private Branch eXchange (PBX). The method provides, for re-routing data (of or associated with the signals) from a first communications device to a second communications device via one of a plurality of networks, comprising the steps of a computing system including a network access point arranged to communicate with the first communications device to receive data and/or information associated with the first communications device and/or with the second communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device. In other words, one broad aspect of the embodiments described herein provides a system for re-routing communications signals, and preferably voice traffic passing through an enterprise PBX, The system provides for re-routing data (of or associated with the signals) from a first communications device to a second communications device via one of a plurality of networks, comprising a computing system including a network access point arranged to communicate with the first communications device to receive data and/or information associated with the first communications device and/or with the second, communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device.

Another aspect of the embodiments described herein provides a method for allocating an identification to a communications device, comprising the steps of a computing system including a network access point arranged to communicate with the communications device to receive data and/or information associated with the communications device, to determine the location of the communications device on the basis of the received data, analyze a plurality of identifications on the basis of decision criteria including the determined location to determine an identification available for allocation to the communications device, and dynamically allocate the determined available identification to the communications device on the basis of the decision criteria.

In embodiments of the invention, the decision criteria may include criteria additional to the determined location including communication tariff cost, network coverage, and security policies.

A further aspect of the embodiments described herein provides a system for allocating an identification to a communications device, comprising a computing system including a network access point arranged to communicate with the communications device to receive data and/or information associated with the communications device, to determine the location of the communications device on the basis of the received data, analyze a plurality of identifications on the basis of decision criteria including the determined location to determine an identification available for allocation to the communications device, and dynamically allocate the determined available identification to the communications device on the basis of the decision criteria.

In embodiments of the invention, the decision criteria may include criteria additional to the determined location, including communication tariff cost, network coverage, and security policies.

Another aspect of the embodiments described herein provides a method for reconfiguring a plurality of identifications, each identification of the plurality of identifications allocated or available for allocation to a corresponding communications device, comprising the steps of a computing system including a network access point arranged to communicate with a first communications device to receive data and/or information associated with the first communications device, to determine the location of the first communications device on the basis of the received data, analyze the plurality of identifications on the basis of decision criteria including the determined location to determine an identification available for allocation to the first communications device, dynamically allocate the determined available identification to the first communications device, and reconfigure the plurality of identifications on the basis of the allocation.

In embodiments of the invention, the decision criteria may include criteria additional to the determined location, including communication tariff cost, network. coverage, and security policies.

A further aspect of the embodiments described herein provides a system for reconfiguring a plurality of identifications, each identification of the plurality of identifications allocated or available for allocation to a corresponding communications device, comprising a computing system including a network access point arranged to communicate with a first communications device to receive data and/or information associated with the first communications device, to determine the location of the first communications device on the basis of the received data, analyze the plurality of identifications on the basis of decision criteria including the determined location to determine an identification available for allocation to the first communications device dynamically allocate the determined available identification to the first communications device, and reconfigure the plurality of identifications on the basis of the allocation,

In embodiments of the invention, the decision criteria n y include criteria additional to the determined location, including communication tariff cost, network coverage, and security policies.

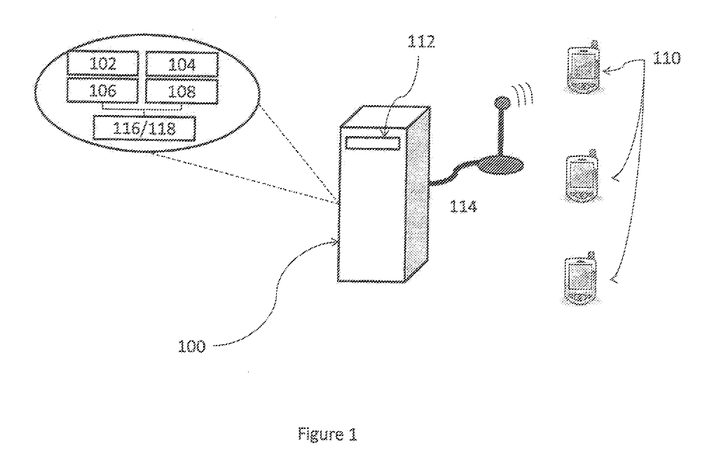

The method is codified in a computing system, such as the computing system shown at FIG. 1.

In FIG. 1 there is shown a schematic diagram of a computing system, which in this embodiment comprises a server 100 suitable for use with an embodiment of the present invention. The server 100 may be used to execute application and/or system services such as a system and corresponding method for re-routing data, along with a system and corresponding method for allocating an identification, and a system and corresponding method for reconfiguring a plurality of identifications, in accordance with embodiments of the present invention.

With reference to FIG. 1, the server 100 may comprise suitable components necessary to receive, store and execute appropriate computer instruction. The components may include a processor 102, read only memory (ROM) 104, random access memory (RAM) 106, an input/output device(s) such as disc drives 108, remote or connected input devices 110 (such as a mobile computing device, a smartphone or a ‘desktop’ personal computer), and one or more communications link(s) 114.

The server 100 includes instructions that may be installed in ROM 104, RAM 106 or disc drives 112 and may be executed by the processor 102. There may be provided a plurality of communication links 114 which may variously connect to one or more computing devices 110 such as servers, personal computers, terminals, wireless or handheld computing devices, or mobile communication devices such as a mobile (cell) telephone. At least one of a plurality of communications link 114 may be connected to an external computing network through a telecommunications network. In embodiments of the invention, at least one of a plurality of communications link 114 may be connected to another computing network, which may comprise a local area network (LAN).

In one particular embodiment the server 100 may include a database 116 which may reside on the storage device 112. It will be understood that the database may reside on any suitable storage device, which may encompass solid state drives, hard disc drives, optical drives or magnetic tape drives, The database 116 may reside on a single physical storage device or may be spread across multiple storage devices.

The server 100 includes a suitable operating system 118 which may also reside on a storage device or in the ROM of the server 100. The operating system is arranged to interact with the database and with one or more computer programs to cause the server 100 to carry out the steps, functions and/or procedures in accordance with the embodiments of the invention described herein.

Other aspects of the broad inventive concept relate to corresponding methods, computer programs, computer readable media and data signals, The methods facilitate the re-routing of data between one or more mobile devices and a centralized phone exchange, allocation of identifications, and reconfiguring identifications.

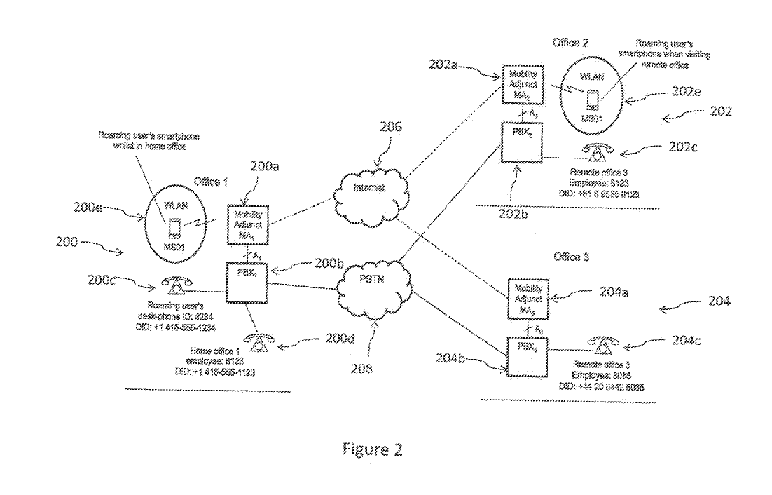

Referring now to FIG. 2, an embodiment of the invention is described with reference to systems 200, 202 and 204. In the example given, each system 200, 202 and 204 represents a physically separate workplace or building (such as, for example, geographically separate offices of a company). The geographic separation is preferably such that they are physically located in different countries or jurisdictions operating independent telecommunications networks.

Each system 200, 202 and 204 includes a computing system 200a, 202a and 204a, (equivalent in functionality to server 100) termed a Mobility Adjunct (MA) which are all turn connected through a public (or private) data network, such as the Internet 206.

Each Mobility Adjunct 200a, 202a and 214a is connected to a corresponding telephone exchange and/or Internet exchange. In the embodiment, each Mobility Adjunct 200a, 202a and 204a is connected to a corresponding Private Branch exchange (PBX) 200b, 202b and 204b, which are all in turn connected to a common Public Switched Telephone Network (PSTN) 208. The PBX's 202a, 202b and 202c operate in a conventional manner, in that they may be connected to one or more conventional fixed line telephones 200c, 200d, 202c, 204c.

The conventional fixed line telephones may be directly connected to the PBX's 200b, 202h, and 202c, or they may be indirectly connected (i.e. they may be a remotely located telephone that is indirectly connected to the PBX via a PSTN network).

Each MA 200a, 202a, 204a is arranged to either connect to an internal Wi-Fi (Wireless Internet technology that utilizes the IEEE 802.11 Standard, a description of which can be accessed at http://en.wikipedia.orglwiki/802.11) network, or may directly provide a wireless facility, so that users located within a defined area may access the associated Mobility Adjunct by using a mobile ,less enabled communication device, such as a smartphone, a tablet or another mobile computing device (200e, 202e), having the required security permissions to make use of the system. Depending on the implementation, the defined area may be indoors, such as, for example, within a workplace or building, outdoors, such as, for example, a public area in a park or street, or it may comprise a combination of both indoor and outdoor venues (i.e. inside an office workplace and in the street outside it). Accordingly, in embodiments of the invention, the defined area may such that a communication device, having the required security permissions to make use of the system, can connect to the associated Mobility Adjunct from a location well away from their office workplace, such a for example a café 100 km away. In such embodiment, determining the location of the communication device based solely on ability to connect to the local office workplace Wi-Fi network is not feasible, and other methods for determining location may be used. These methods may include one or more of: querying a position sensor and/or navigation system of the device, which may comprise a Global Positioning System (GPS), to determine ifs location: and using a service that determines location based on what network access point(s), which may include Wi-Fi access points or cell sites associated with cellphone towers, are visible (available) to the device, and as described at, for example http://www.skyhookwireless.com/howitworks/ or http://developers.google.com/maps/documentation/business/geolocation/), to determine its location.

The Mobility Adjunct routes cans originating from both mobile communications devices and fixed line devices (whether internal or remote) through either a Voice over Internet Protocol (VoIP) solution via Internet 206, or alternatively via PSTN 208.

It will be understood that any suitable criteria may be utilised as a basis on which to make a decision to re-route calls through one network as opposed to another. Often, this decision may involve a compromise or trade-off between communication path optimisation and costs. In one embodiment, the decision to re-route calls may be based solely on which network can provide the lowest monetary cost for the particular call. In other embodiments, the decision to re-route may be based on a mixture of factors, such as the cost combined with the known quality and bandwidth of each particular network.

This is achieved through maintenance of a database of information (parameters) regarding local call rates, PBX dial plans and routing tables, and any other information relevant to the decision to re-route the call, which in turn is called upon by a process (i.e. an application) which runs an algorithm on each Mobility Adjunct and is specifically arranged to provide an optimized set of values for both fixed line and mobile number called party charges for a given user.

In the embodiment described, the decision is such that if the PSTN 208 is available for the communication it is the first choice, with VOIP via Internet 206 being the second choice (as a consequence of potential quality of service issues known to be associated with VOIP communications over long distances). At present charge rates, either of these options is much less expensive that incurring the high roaming tariffs. For example, presently, an international mobile call back to Australia will typically cost approximately $4 per minute from many countries (UK $2.95, US $3.35, China $4.47, Japan $3.90, Italy $5.00, Germany $4.17). Presently, calls made to another country while travelling overseas with an Australian mobile phone will typically cost from 40% to 100% of that figure, depending on the country. A comparable business call via PSTN will cost approximately $0.02 per minute. Further information may be found at and http://www.telstra.com.au/mobile-phone/international-roaming/pricing-compatability/ and http://www.telstra.com.au/business-enterprise/download/document/buiness-telephony-businessline-id-rates-1.pdf in this regard.

Accordingly, the decision criteria may include criteria additional to the determined location including, for example, communication tariff cost, network coverage, and security policies.

Mobile Phone Interaction with the System

As previously described with reference to FIG. 2, each server (“Mobility Adjunct” (MA)) is connected to an administrative interface (such as Cisco s Administrative XML Layer (AXL)) of a PBX (such as the Cisco Unified Call Manager (CUCM) platform) that provides a specific population of users (in this example, office employees) with office voice connectivity services. The respective administrative interface that each MA connects to may vary.

Each MA is aware of a local population of employee that have both a fixed desk-phone extension and an “enhanced” smart-phone, provisioned with additional software capabilities via the provision of an ‘App’ (or embedded in the Operating System or firmware of the phone). The ‘App’ provides an Enhanced Voice Client (EVC) that facilitates communications to a MA.

The smartphone can signal their presence to a MA without user intervention, and additionally can place VoIP calls over the local Wi-Fi network to the MA and/or the associated PBX. The MAs are furthermore connected to each other through a data network that permits the transmission of messages from one MA to another. In embodiments of the invention, a central server (not shown) may be provided, to which at least a selection of the MAs are connected to facilitate administration of the MAs, including monitoring and controlling the operation thereof and tracking of data flow there between.

Each EVC-enhanced smartphone is capable of detecting a MA associated with a remote office belonging to the same organisation, when the user associated with the mobile phone has roamed over to that remote office and uses his phone to access the Wi-Fi network in that remote office. This will typically occur when the user, carrying their associated mobile phone, walks or steps into the defined communication area associated with the MA (arising from, its respective network, access point(s)).

It should be noted that the invention is not limited in this regard, and in alternative embodiments MAs may be located in offices owned by differing organisations having agreements allowing use of the system by any authorized user having the appropriate security permissions, regardless of the organisation they belong to

The data and/or information associated with the mobile phone may include one or more of: an original identification for the mobile phone; a temporary identification for the mobile phone; an identification of an originating location of the mobile phone; and an identification of a present location of the mobile phone.

For voice communications, a user normally has one or more phone numbers or IDs on which he/she can be reached. That is, the user normally has a known fixed line office extension number (i.e. a Fixed, User ID or FID) which is known globally through its full E.164 Standard address (reference to the Standard can be found at http://en.wikipedia.org/wifi/E.164).

In audition the user will most likely have a mobile phone, which also has a E.164 address on which the user can be reached (i.e. a Mobile User ID or MID).

In embodiments of the invention, the original identification for the mobile phone may comprise the MID. The FID may comprise an additional identification for the mobile phone, and be part of the data and/or information associated with the mobile phone. In such a case, diversions of both mobile phone calls, arising from use of the MID, and desk phone calls, arising from use of the FID, may be handled by the system.

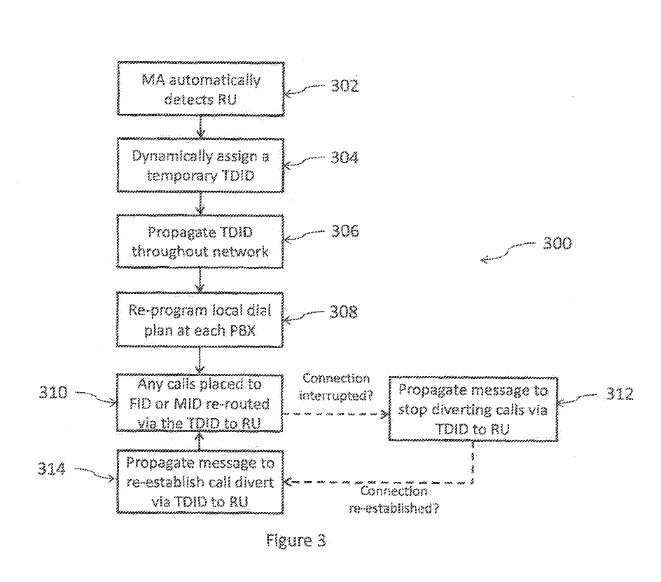

Referring now to FIG. 3, there is depicted a process flow 300 which outlines the interaction that occurs between the server and the user's mobile device as the user roams from one office to a remote office.

At step 302, the remote MA detects automatically, or is otherwise made aware of, the presence of the roaming user's mobile phone (RU) in the associated remote office, In embodiments of the invention, this may be implemented by the RU providing an indication that it is within the defined area. The MA is operable to automatically receive the indication and hence detect the presence of the RU, and determine that the location of the RU corresponds to the location of the defined, area (and the MA).

The identification of the originating location of the mobile phone (of the data and/or information associated with the mobile phone) specifies the home office location of the user.

In the embodiment, the identification of the presentation of the mobile phone is as determined by the MA.

At step 304, the MA automatically assigns a dynamically-allocated temporary direct in-dial (TDID) identity to the U. In the embodiment, the TDID corresponds to the temporary identification for the mobile phone. In the embodiment, a plurality of numbers (identifications) are analyzed to determine a number (identification) available for allocation as the TDID, and the determined TDID is dynamically allocated.

The TDID, which also may be referred to as a surrogate number may be determined on the basis of a configuration parameter. In embodiments of the invention, TDIDs available for automatic allocation are determined during a deployment or setting up stage of the associated MA, which may involve analysis comprising querying the PBX for which numbers are used, and which are free to allocate for temporary use. The querying may comprise scanning for ‘white space’ (free numbers) in the indial range of the PBX, following which one of the free numbers identified in the white space is allocated to the RU. Although in embodiments of the invention the white space recognition may comprise looking for and identifying a single unused (available) number to be allocated to a communications device operated by a user visiting the area of the MA, in the described, preferred, embodiment it comprises scanning the PBX dial plan to look for and identify blocks each comprising a plurality of sequential unused (available) numbers for reservation for use by the system, and then reserving at least the largest available block identified for use. This advantageously avoids or mitigates interference and clashes with changes that an administrator of the PBX may wish to make to the dial plan manually.

In the embodiment, following the dynamic allocation of the TDID, each of the plurality of numbers (identifications) is reconfigured accordingly.

At step 306, the MA then propagates the user's TDID to all MA's in the network, so that the user's mobile phone can be contacted via the network, This may be done via the central server in embodiments where present.

At step 308, each MA then automatically and dynamically re-programs or reconfigures the local dial plan associated with their co-located PBX, with the effect that any calls placed by a local user (who is (i.e., via a communications device) attached to any of the plurality of PBXs) to the RU's home FID or MID are diverted to the TDID referred to above. In this manner, in the embodiment, the dial plan of each PBX of the plurality of PBXs is changed, and preferably optimized, based on the geo-location of user carrying the RU.

It should be appreciated that the above is the case for local users communicating via communications devices attached to any of the plurality of PBXs. The operation is somewhat different, in the embodiment, for calls placed by a local user using a communications device which is not so attached In such a situation, the local FID is handled by the local PBX, so calls to it can be redirected to the TDID, using the diversion and translation pattern features of the PBX, which directs calls to the mobile phone at the remote location. Local calls made to the MID in such a situation, however, are not under the control of the local PBX, so calls made to the MID are routed via the international mobile system to the user's mobile phone independently of the system of the embodiment. This may be the desired behavior. That is, work calls made to the RD get redirected, but personal calls are not carried by the corporate network, A user may inform friends and family that if they wish to make contact while they are travelling, to call on, the work number (FID), in which case the call will get redirected through the system. Alternatively, a user may redirect their MID to their FID in which case all mobile calls received will be redirected through the system. In an alternative embodiment of the invention, the MA is operable to automatically redirect calls made to a MID (regardless of whether the calling communications device is connected to an MA or not).

Therefore, at step 310 when a call is placed to an FID (or an MID from a communications device connected or attached to the local MA), the local MA ensures that such calls are routed to the RU via the TDID. It should be appreciated that the TDID is not called directly by the user The TDID is hidden internally and not revealed to the user, who just uses the FID and/or MID as appropriate as they normally would.

At step 312, if the connection between the RU and the remote MA is interrupted, for example due to the RU leaving the Wi-Fi coverage of that office, then the MA signal to the rest of the plurality of MAs to cease diverting calls via TDID and resume their previous dial plan for that RU. At step 314, if the connection is re-established between the most recent MA and RU, then another signal is sent to all other MAs to re-establish the diversions via TDID for that RU's FID and MID.

It should be appreciated that, in the embodiment, the configuration of the PBX is dynamic, and updated and reconfigured automatically on the fly as the user carries their mobile phone from the defined area of one MA to another. As long as the mobile communications device has been configured with required security including passwords and permissions to log into the appropriate Wi-Fi networks, the moving into and out of defined areas by the user is recognized, and preferred call routes are established seamlessly and automatically.

The PBX configurations are not static as traditionally is the case. Rather, a heterogeneous network of PBXs is provided, with different PBX's (associated with different MAs) having their dial plans and settings reconfigured according to users movements.

### Advantages

One of the advantages of the embodiments and broader invention described herein is that the system and method are capable of dynamically managing the phone usage and voice traffic paths for a global organisation, or an ensemble of individual regional offices, by providing fixed-line voice numbering plan continuity for users that roam from one office to another.

In embodiments where it is extended to allowing use by anyone registered, regardless of the organisation they work for the invention may be universally applicable to anyone travelling on business, or generally.

In other words, the embodiment adds a roaming capability to the existing network of PBX within a large multi-office organisation, so that fixed (and in certain cases mobile) voice profiles can automatically follow a user when visiting a remote office, whilst being routed over the high-quality low-cost PSTN.

As a corollary, the use of automatic voice data routing and dial plan changes enable an optimal, lower-cost voice route to be established for both fixed line and mobile phone connections.

The embodiment is arranged to automatically handle the necessary diversions required at each office location to allow any employee to call a roaming user on their normal fixed or mobile numbers, whilst having such calls automatically routed using the lowest cost route possible over the public switched telephone network, without any “call tromboning” or any resorting to a mobile roaming mechanism.

Moreover, the embodiment implements a network-wide presence management for such roaming users, so that when they enter or leave a remote office, a light-weight signaling is used to set or reset the previously requested diversions at all other office locations.

### Disclaimers

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Although not required, the embodiments described with reference to the method, computer program, data signal and aspects of the system can be implemented via an application programming interface (API), an application development kit (ADK) or as a series of program libraries, for use by a developer, for the creation of software applications which are to be used on any one or more computing platforms or devices, such as a terminal or personal computer operating system or a portable computing device, such as a smartphone or a tablet computing system operating system or within a larger server structure, such as a ‘data farm’ or within an enterprise transaction processing system.

Generally, as program modules include routines, programs, objects, components and data files that perform or assist in the performance of particular functions, it will be understood that the functionality of the software application may be distributed across a number of routines, programs, objects or components to achieve the same functionality as the embodiment and the broader invention claimed herein. Such variations and modifications are within the purview of those skilled in the art.

It will also be appreciated that where methods and systems of the present invention and/or embodiments are implemented by computing systems or partly implemented by computing systems then any appropriate computing system architecture may be utilised. This includes standalone computers, network computers and dedicated computing devices (such as field-programmable gate arrays).

Where the terms “computer”, “computing system” and “computing device” are used in the specification, these terms are intended to cover any appropriate arrangement of computer hardware for implementing the inventive concept and/or embodiments described herein.

Where reference is made to telecommunication standards, methods and/or systems, it will be understood that such standards, method and/or systems are provided by way of example only, and it will be understood that a mobile device may transmit and receive data via any suitable form including but not limited to 3G, 4G (CDMA/GSM), Wi-Fi, Bluetooth, other radio frequency, optical, acoustic or magnetic form or method of communication that may become available from time to time.

1-50. (canceled)

51. A method for re-routing voice data from a first communications device to a second communications device via one of a plurality of networks, wherein at least one of the plurality of networks includes a Public Switched Telephone Network (PSTN), the method comprising the steps of a computing system including a network access point communicating with the first communications device to receive data and/or information associated with the first communications device and/or with the second communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device, the network including the PSTN being selected according to criteria including quality of communication between the first communications device and the second communications device.

52. The method in accordance with claim 51, wherein the step of determining the location of the first communications device comprises one or more of: establishing a connection for the communication between the first communication device and the computing system via the network access point, and determining the location of the first communications device on the basis of the connection being established; querying a position sensor and/or navigation system of the first communications device to determine the location of the first communications device; and using a service that determines location based on what network access point(s) are visible (available) to the first communications device to determine the location of the first communications device.

53. The method in accordance with claim 51, wherein the data and/or information associated with the first communications device comprises an indication that the first communications device is within a communication area associated with the network access point within which it is operable to establish a connection, the method comprising the further steps of automatically receiving the indication from the first communication device when it enters the communication area, and determining that the location of the first communications device corresponds to the location of the communication area.

54. The method in accordance with claim 51, wherein the data and/or information associated with the first communications device includes one or more of: an original identification for the first communications device; an identification of an originating location of the first communications device; and an identification of a present location of the first communications device.

55. The method in accordance with claim 54, wherein the method comprises the further step of assigning a temporary identification to the first communications device, preferably in the form of a temporary identification number, such a Public Switched Telephone Network (PSTN) indial number.

56. The method in accordance with claim 51, wherein the data and/or information associated with the second communications device includes one or more of: an original identification for the second communications device; a temporary identification for the second communications device; an identification of an originating location of the second communications device; and an identification of a present location of the second communications device.

57. The method in accordance with claim 51, comprising the further step of propagating at least some of the data and/or information associated with the first communications device and/or the second communications device to at least one other computing system on at least one of the plurality of networks.

58. The method in accordance with claim 57, wherein the at least one other computing system comprises a telephone exchange and/or an Internet exchange.

59. The method in accordance with claim 58, wherein the telephone exchange comprises a Private Branch eXchange (PBX).

60. The method in accordance with claim 58, comprising the further steps of reconfiguring the telephone exchange and/or the Internet exchange to connect the first communications device and the second communications device.

61. The method in accordance with claim 60, wherein the reconfiguring occurs automatically on the occurrence of a prescribed event.

62. The method in accordance with claim 61, wherein the prescribed event comprises determination of the location of the first communications device.

63. The method in accordance with claim 51, comprising the further step of utilising at least one parameter and an algorithm to select the one of the plurality of networks.

64. The method in accordance with claim 63, wherein the at least one parameter is the monetary cost of utilising the each one of the plurality of networks to connect the first communications device to the second communications device.

65. The method in accordance with claim 51, comprising the further step of testing the at least one of the plurality of networks utilised by the resultant connection between the first communications device and the second communications device to determine the connectivity of the first communications device to the second communications device.

66. The method in accordance with claim 51, wherein at least one of the plurality of networks is an Internet Protocol (IP) network.

67. The method in accordance with claim 51, wherein at least one of the first communications device and the second communications device is a mobile (cell) telephone.

68. The method in accordance with claim 51, wherein at least one of the first communications device and the second communications device is a fixed (land) line telephone.

69. The method in accordance with claim 51, wherein the second communications device comprises the intended endpoint for a communication from the first communications device.

70. A system for re-routing voice data from a first communications device to a second communications device via one of a plurality of networks, wherein at least one of the plurality of networks includes a Public Switched Telephone Network (PSTN), the system comprising a computing system including a network access point arranged to communicate with the first communications device to receive data and/or information associated with the first communications device and/or with the second communications device, and to determine the location of the first communications device and the location of the second communications device on the basis of the received data and/or information, wherein upon determining the location of both the first communications device and the second communications device, the computing system selects one of the plurality of networks to connect the first communications device and the second communications device, the network including the PSTN being selected according to criteria including quality of communication between the first communications device and the second communications device.
